(19) United States
(12) Patent Application Publication
(10) Pub. No.: US 2012/0036949 A1
(43) Pub. Date: Feb. 16, 2012

(54) PLANETARY CHAIN DRIVE MOTION CONVERTER AND METHOD FOR CONVERTING MOTION USING CHAIN DRIVES

(76) Inventor: Aleksandr Solomonovich Markon, Moscow (RU)

(21) Appl. No.: 13/258,810

(22) PCT Filed: Jul. 2, 2010
(86) PCT No.: PCT/RU2010/000370

§ 371 Date: Oct. 19, 2011

(30) Foreign Application Priority Data
Jul. 3, 2009 (RU) 2009126490

(51) Int. Cl. F16H 19/06

(52) U.S. Cl. 74/37

(57) ABSTRACT

The invention concerns to the area of mechanical engineering, in particular, to the ways and devices for summation of reciprocal-linear motions and for transformation of the summarized motion into unilateral rotation. The essence of the invention is a planetary chain-drive in which the chain is a driving part (1), the chain is moved reciprocally by a carrier with mobile, satellite sprockets (2) and (3) separate parts of the chain move with different speeds.

The invention, i.e. both the mechanism-converter and the transformation method, concerns to the area of mechanical engineering, in particular,

to mechanisms and methods for conversion, transformation of reciprocal-linear motion of a driving member of a kinematic chain of a mechanism into unilateral rotation of its (of the mechanism's) drived member, and
to mechanisms and methods for summation of motions of several driving members onto a sole drived member.

Both the mentioned problems are simultaneously solved by the invention.

The essence of the invention is a planetary chain-drive in which
(1) its chain is its driving member,
(2) the chain is moved reciprocal-linearly by a pusher directly and/or by carriers through the satellite sprockets, which are placed on the carriers and create mobile/dynamic closing of the chain contour, and
(3) separate parts of the chain move with different speeds—all these are essentially new for the theory of machines and mechanisms.

For transformation of reciprocal-circular, i.e. oscillatory, swing motion into interrupted monotonous rotation can be used a freewheel which within the limits of the technology state is used to prevent spontaneous drive of rotation from drived elements back to driving ones.

In the technology state the invention has analogues by several factors—by functional ones and by constructive one.

The most close analogue by the functional factor of motion transformation is the rack-gear gearing in combination with a free-wheel, that has smaller functional abilities comparing with the invention as it will be shown from the further description.

The most widely applied functional analogue, in particular, in piston engines, is the crank-drive mechanism. The main its lacks, deficiencies are
the loss of a part of the effort transferred, on the average during its working course, from a leading sliding-block, from an engine piston, that results in decrease in efficiency too, and
the presence of dead points that results in the full loss of this effort nearby these points and in mechanism jamming.

A constructive imperfection of this mechanism is principle limitation of its sliding-block course: it cannot be longer than the doubled length of its crank; this also results in decrease in the efficiency.

The similar task to convert, to transform the oscillating (reciprocal circular, rotational) motion into the unilateral rotation is solved by means (of using) of, four-bar-linkage with driving/leading rocker and a driven/conducted crank, in particular, in a manual drive of an invalid wheelchair. The same imperfections are inherent in this device as in crank-drive one.

The closest functional analogue by motions summation is the planetary tooth gearings. But only rotations can be summed by it, not straight linear motions.

The closest constructive analogue is a chain-drive. But the chain-drive can only transmit rotation, and can neither convert, transform linear motions nor sum them.

The technical problem, solved by the invention, can be formulated as creation of a mechanism and a method for convertion/transformation of reciprocal-linear motion of a driving member of a mechanism kinematic chain into unilateral rotation of this mechanism's driven member, and for summation of reciprocal?linear motions of several driving members onto one driven member.

The essence of the invention is transformation/convertion of linear motion into circular one by means of chain-sprocket toothing/gearing, i.e. transformation of a chain of a chain-drive into the driving member instead of an intermediate/auxiliary linking member of the chain-drive.

The technical result, which can be received by means of the invention, is (1) summation of several simultaneous reciprocal-linear motions, without some principle restrictions on their directions and forms of their trajectories; motions made either manually or mechanically, for example, by a piston of a piston engine, and also (2) transformation of the summarized reciprocal-linear motion into unilateral rotation with or without idling.

This result is realized due to transformation of reciprocal-linear motions into unilateral rotation by means of free-wheel; at that reciprocal-linear motion of at least one driving element of a chain of at least one working chain-drive is transformed into reciprocal rotation of at least one working chain-wheel of this chain-drive; and further, by means of at least one free-wheel, the reciprocal rotation is transformed into unilateral rotation of at least one executive element.

The invention allows to intensify energy output at muscular drive due to liquidation of necessity/inevitability of unproductive/auxiliary/idle motions, and due to possibility to increase usage of working motions, and also allows to raise efficiency of a machine drive, in particular—comparing with a crank-drive transformer, which is most widely applied now, and, under certain conditions,—comparing also with a turbine drive, so that it can be used for drive of many devices, in particular, for muscular
transport devices/vehicles with 2-3-4- and more, up to 6-8, wheels,
propeller screw swimming devices,
health and sport traing devices, electrogenerators, pumps, etc.—for energetic devices, motion sources, piston engines
chemical—burning, oxidation—both of external and of internal combustion,
physical—nuclear splitting, etc.

In one of the mechanisms representing the invention, the driving chain 2 is moved by a constructive element 6 which is rigidly fixed with the driving chain 2, and which is further named “a pusher”.

In another mechanism, representing the invention, the driving chain 2 is moved by a constructive element 4, named further “a carrier”, connected with the driving chain 2 through a pair of sprockets 5, named further “satellites”, which axes are fixed on the carrier 4; sprockets 5 are toothed with the driving chain 2 on the “external” side of its contour, i.e. on the side opposite to the working sprocket 10; so a mobile/dynamic closing of the driving chain 2 contour is made; so the speed of various branches of the driving chain 2 are various; and such a chain-drive, i.e. a complex a chain and all sprockets toothing it, with such a closing are named further “planetary chain-drive”.

In another mechanism, representing the invention, the driving chain 2 is moved by at least two carriers 4.

In another mechanism, representing the invention, at least two driving chains 2 are set in motion by one carrier 4. In another mechanism, representing the invention, the motion is transmitted from the driving chain 2 onto an executive element 7 by means of an auxiliary chain 13; at that the motion is transmitted onto the chain 13 by means of two pairs of coaxial sprockets 14, 16 and 15, 17, and each of these pairs connect among themselves through a freewheel 9, at that sprockets 14, 15 are toothed with the driving chain 2 on the different sizes of its contour, and the freewheel 9 are directed equally.

In another mechanism, representing the invention, the motion is transmitted from the driving chain 2 onto an executive element 7 by means of an auxiliary chain 13; at that the motion is transmitted onto the chain 13 by means of two pairs of coaxial sprockets 14, 16 and 15, 17, and each of these pairs connect among themselves through a freewheel 9, at that sprockets 16, 17 are toothed with the auxiliary chain 13 on the different sizes of its contour, and the freewheel 9 are directed contrary.

The claimed solutions are explained by following figures of drawings, where

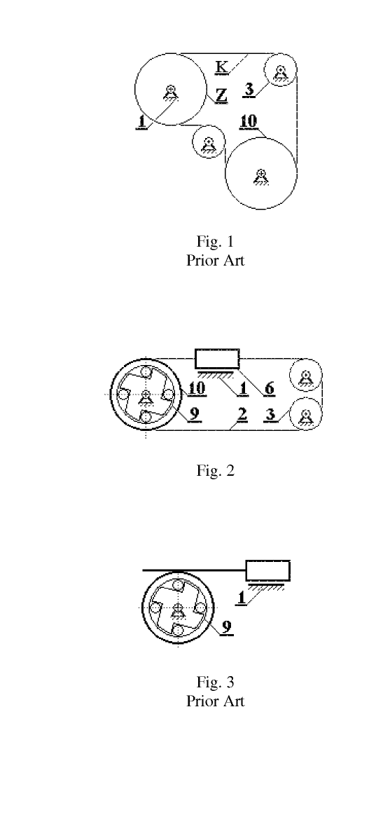

on the FIG. 1 the kinematic scheme of a usual chain-drive, known in the technics state, is shown for comparison;

on the FIG. 2 the kinematic scheme of the simplest, base variant of the invention is shown;

on the FIG. 3 the kinematic scheme of a rack-gear-drive, known in the technics state, is shown for comparison;

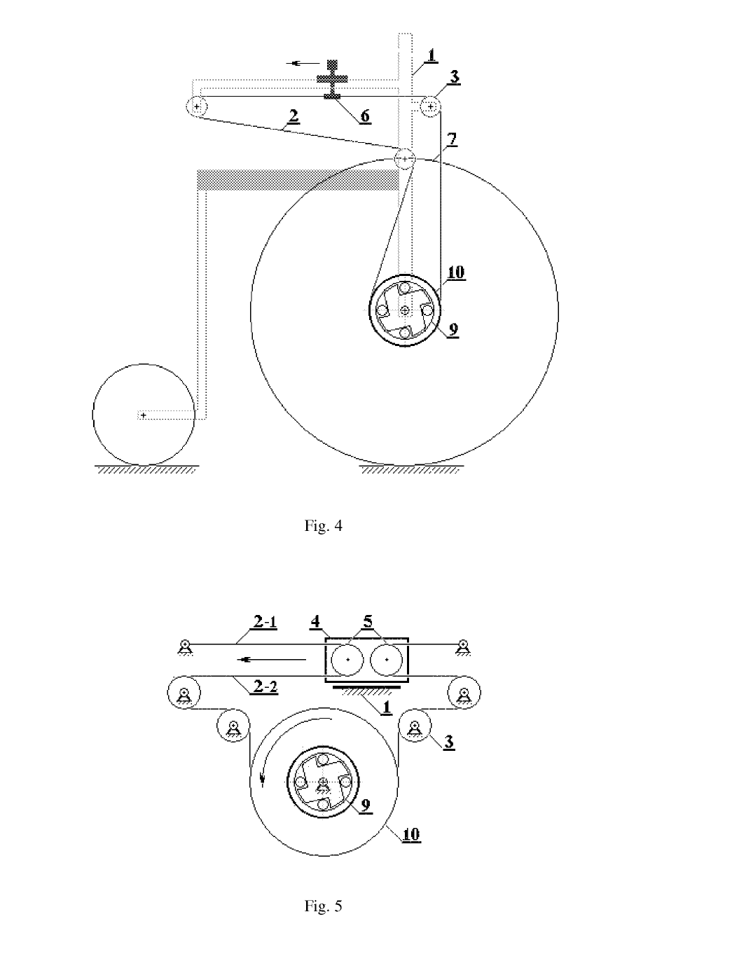

on the FIG. 4 the scheme of an invalid wheel-chair with a handle-chain-drive is shown as an example of practical using of the base variant of the invention;

on the FIG. 5 the kinematic scheme of a planetary chain-drive is shown;

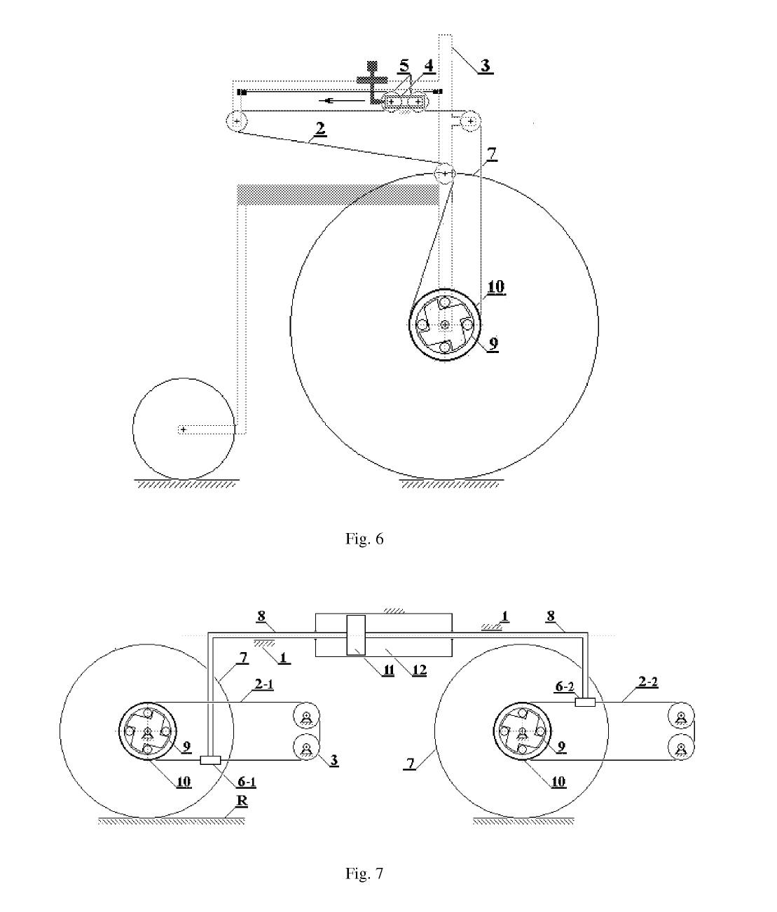

on the FIG. 6 the kinematic scheme of an invalid-chair with a handle-chain-drive is shown as an example of practical using of the planetary chain-drive;

on the FIG. 7 the kinematic scheme with two chain-drives moved by a sole pusher in order to eliminate from idlings is shown;

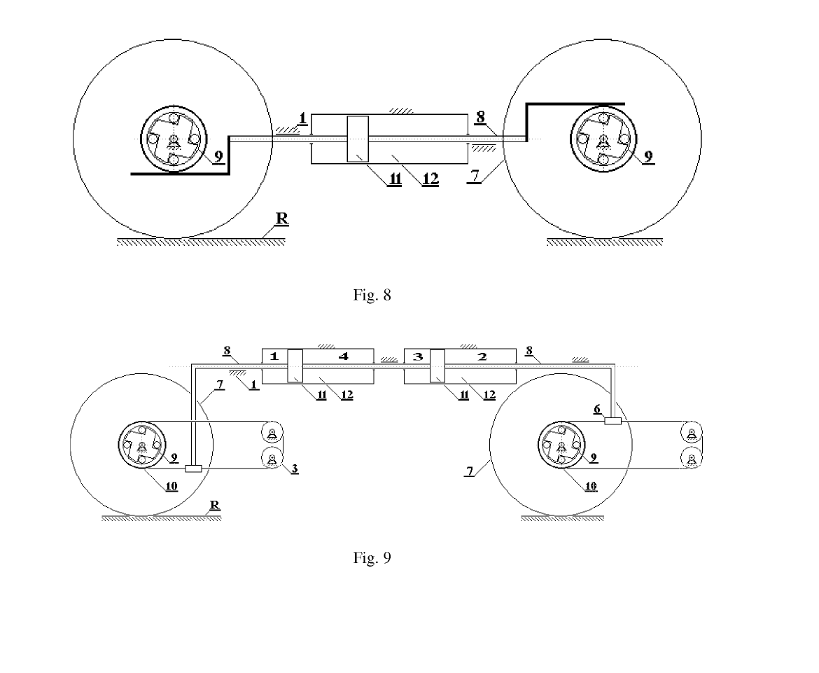

on the FIG. 8 the scheme similar to the FIG. 7 is shown, but it is with rack-gear toothing, that shows the ability to realize the invention not only by means of chain-drives;

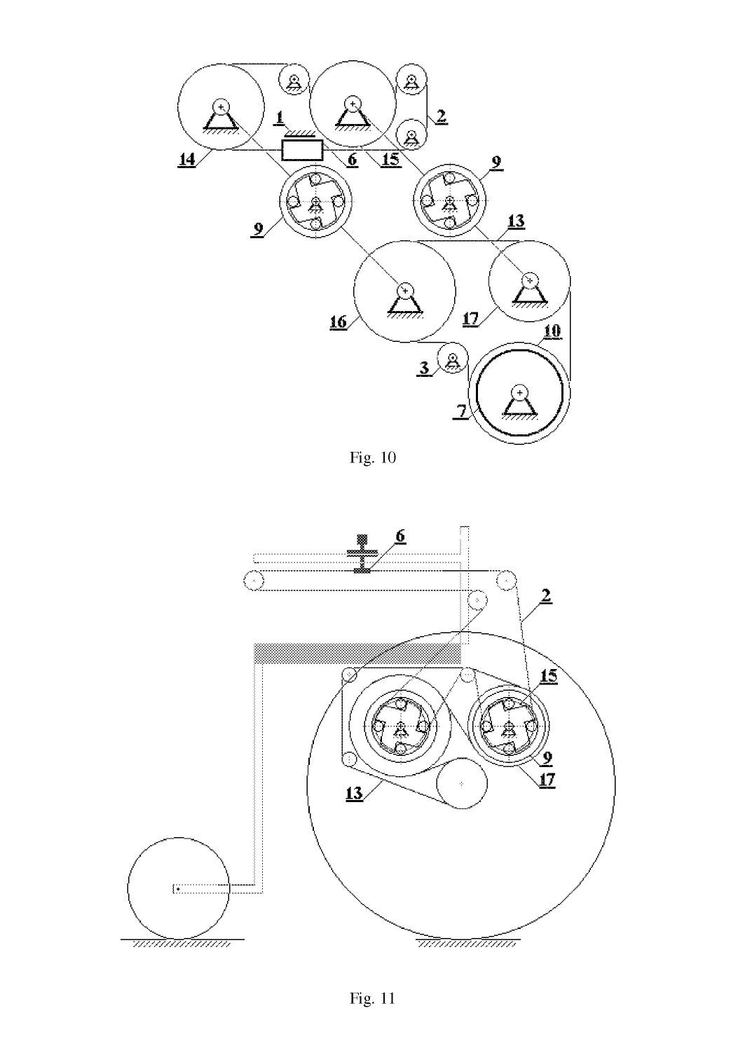

on the FIG. 9 the scheme similar to the FIG. 7 is shown, but it is with two piston engines that shows advantages of the invention, in particular—the absence of constructive restrictions both on a quantity of pistons, and on a length of their course;

on the FIG. 9 the scheme similar to the FIG. 7 is shown, but there is an engine here with two pistons instead of four, that shows advantages of the invention, in particular—the absence of constructive restrictions both on a quantity of pistons, and on a length of their course;

on the FIG. 10 the scheme is shown which can be used in order to eliminate from idlings and which has an auxiliary chain and free-wheels directed equally;

on the FIG. 11 the scheme of a manual-drived invalid-chair is shown with an auxiliary chain and two free-wheels directed contrary;

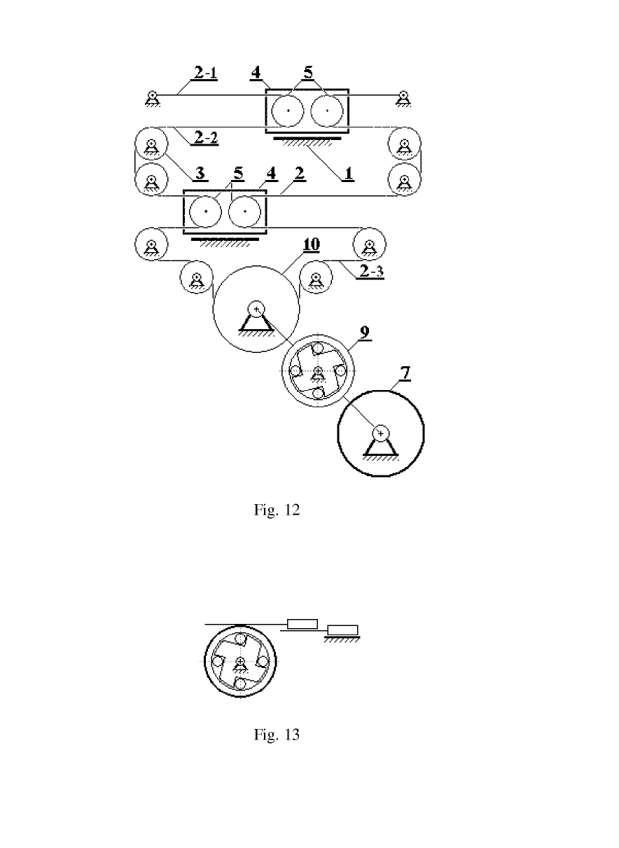

on the FIG. 12 the kinematic scheme of a planetary chain-drive with two carriers is shown;

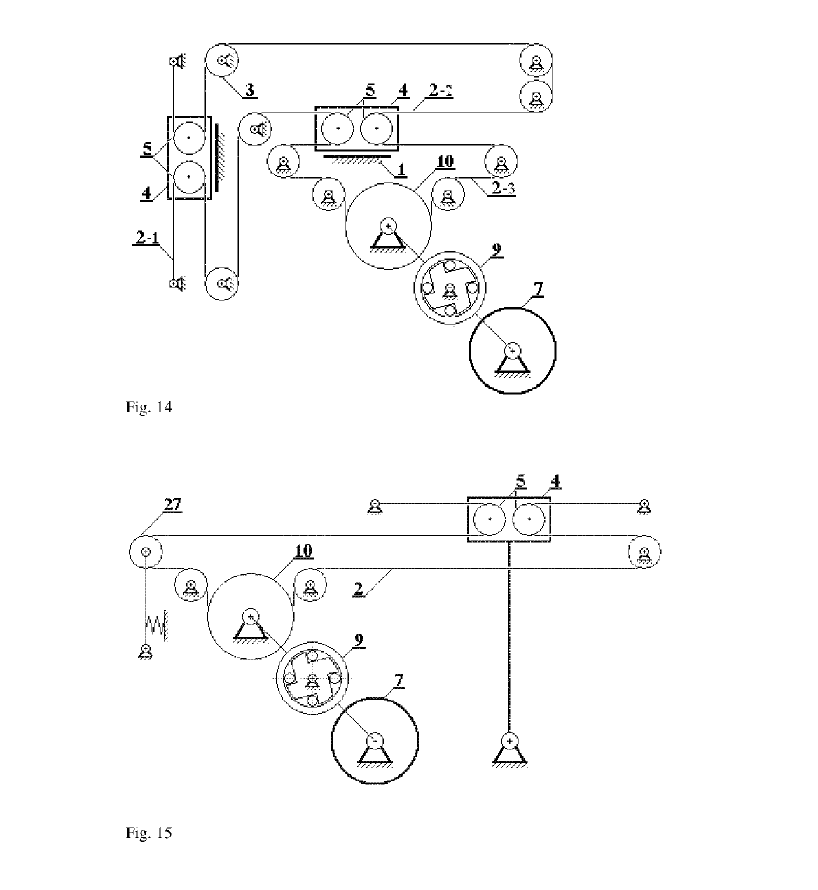

on the FIG. 13 the kinematic scheme similar to the FIG. 12 is shown in order to show that using of rack-gear-drives involves constructive restrictions;

on the FIG. 14 the modification to the FIG. 12 with carriers moving along not parallel trajectories is shown;

on the FIG. 15 the modification to the FIG. 12 with a carrier moving not translationally is shown;

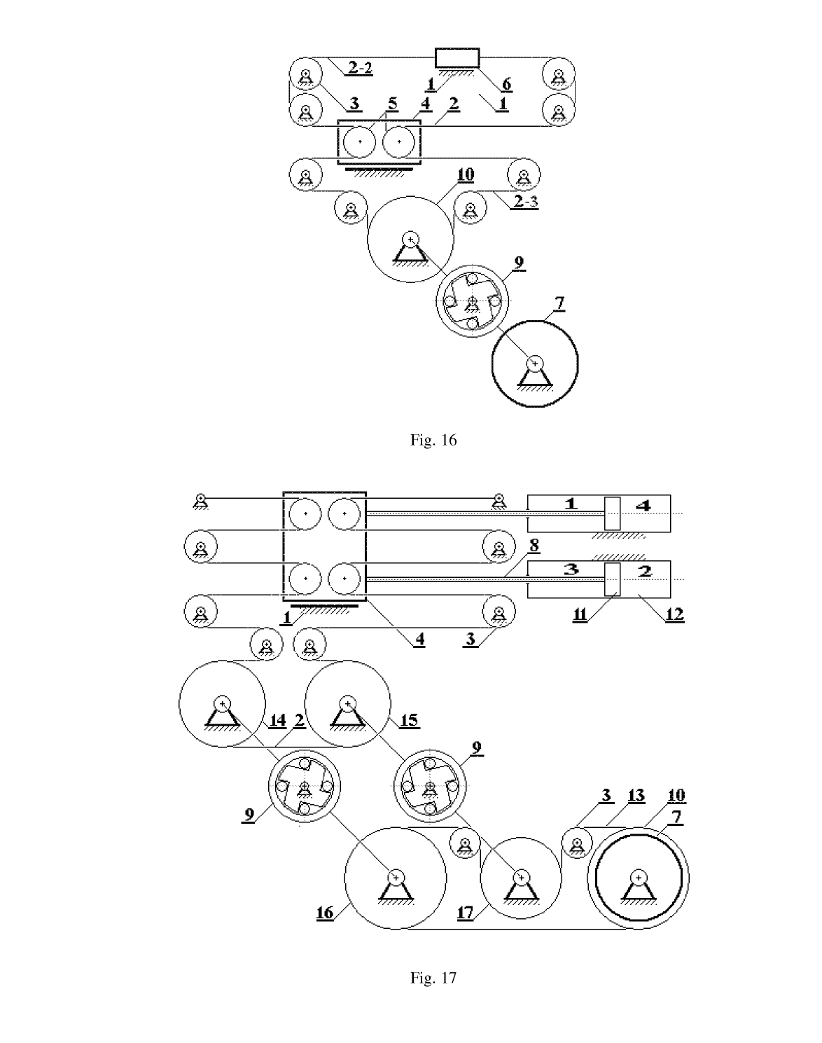

on the FIG. 16 the kinematic scheme with the driving chain which is moved by both a pusher and a carrier is shown;

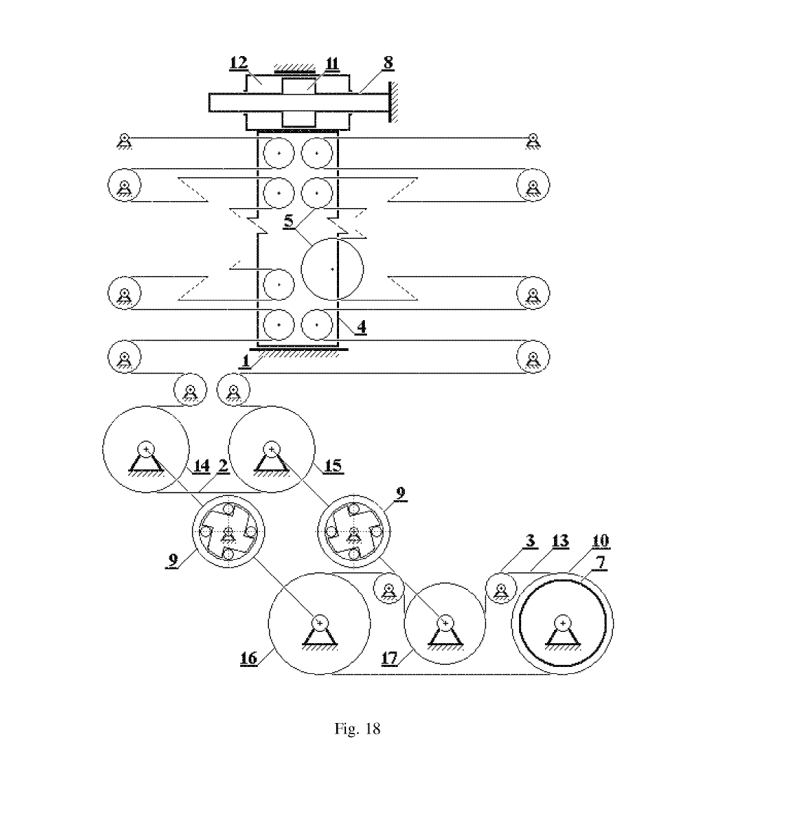

on the FIG. 17 the kinematic scheme with a doubled carrier which is moved by pistons of 4-stroke 2-cylinder internal-combustion engine is shown, i.e. a functional substitution for a crank mechanism;

on the FIG. 18 the kinematic scheme is shown with a tripled carrier which is moved by a cylinder of a piston engine with a piston fixed on a mechanism frame, i.e. a functional substitution for crank mechanism too;

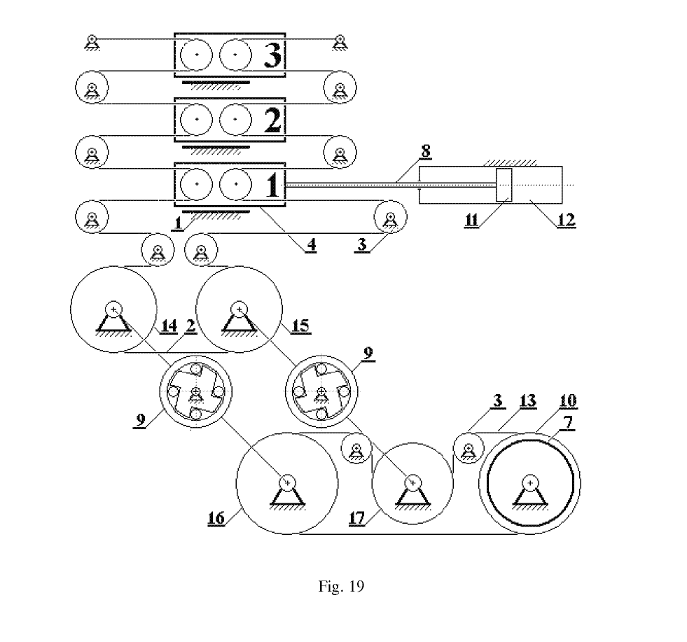

on the FIG. 19 the kinematic scheme is shown with three carriers, two of which can alternately be fixed rigidly either on a frame, i.e. be fully braked, or be fixed with a rod of a piston engine, that allows to regulate in steps the speed of an executive element and that is a functional equivalent of a transmission box;

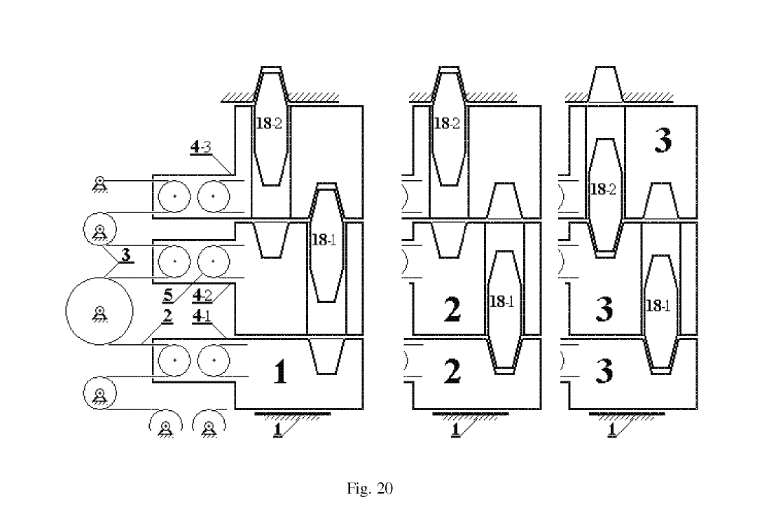

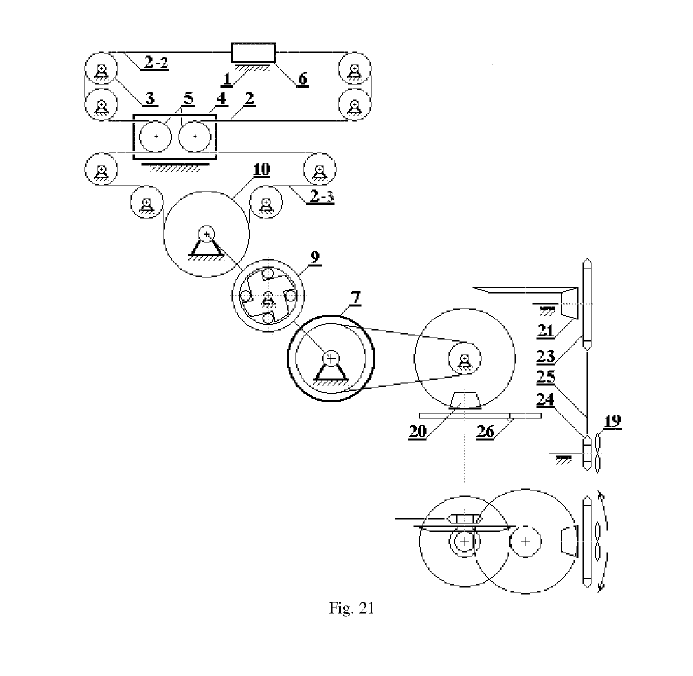

on the FIG. 20 a scheme of the simplest constructive variant of such transmission box by means of two latches is shown;

on the FIG. 21 a kinematic scheme for a floating device with muscular drive using the invention. is shown.

The essence of the invention, of the claimed solution consist in
the toothing chain-sprocket is used instead of the rack-gearing, that allows to expand functional abilities of the converter-summarizer, diminish its sizes and increase its constructive flexibility;
for the first time a chain of chain-drive becomes its driving member but not its intermediate member;
for the first time a physically unfastened chain is used with a dynamical, mobile, planetary closing;
an auxiliary chain is included into the converter-summarizer; rotation is passed to the auxiliary chain through two freewheels, that allows to be released from idlings.

The variants of the mechanism, illustrating here abilities of the invention realizing and advantages of its using, are not limiting for the invention.

In the FIG. 1 the kinematic scheme of an usual chain-drive, known in the technology state, is shown for comparison with the invention; here
(1) rotation is transmitted by a chain 2 from a driving sprocket Z to all other sprockets;
(2) the driving sprocket Z is rotated by a shaft on which it is fastened; and
(3) axes of all sprockets are motionless concerning a frame 1 of the kinematic scheme or, that is the same, of the mechanism frame.

In the FIG. 2 the kinematic scheme of a mechanism variant is shown, which is the base, simplest in the invention; here
(1) the chain 2 is driving, and all sprockets are driven;
(2) the driving chain 2 is moved reciprocally (i.e. has back-and-forth motion) by a pusher 6; on the FIG. 2 the pusher 6 is shown as a slider, moving rectilinearly and translationally, but in principle the pusher 6 can move both not rectilinearly and not as translation, as it will just be shown further;
(3) reciprocal-rotary motion, swing rotation of the working sprocket 10 is transformed into the interrupted unidirectional rotation of a driving member of the executive device at its transfer through a free-wheel 9.

In the FIG. 3 a similar transformer with the rack-gear toothing is shown in order to compare with the chain-sprocket, i.e. known in technology state. Each of these two constructive variants, shown in the FIGS. 2, 3, has its advantages and deficiencies. Which one of them is preferable depends on what specific technical problem is solved.

In the FIG. 4 an example of practical application of the basic variant of the invention according to the FIG. 2 is shown, namely—for muscular drive of a wheelchair. Here the working wheel 7 of the wheelchair 1, the executive part of the mechanism, rotates counter-clockwise when the pusher 6 moves to the left, along the arrow, and continues to move by inertia when the pusher 6 moves backwards, to the right,—at idling. A working sprocket 10 and a free-wheel 9 are placed coaxial to the wheel 7. [Such a using of the invention will allow to an invalid-wheelchair-driver to move fast as a runner, for the construction eliminates non-ergonomic motions.]

In the FIG. 5 a variant of the invention with a planetary-chain-drive is shown; in contrast to the basic variant according to FIG. 2, here the driving chain 2 is opened/torn and its ends are fixed rigidly to the frame 1, at that a pusher 6 is replaced by a carrier 4; at that speed of the driving chain 2 in its section 2-1 is zero, while it is equal to the twice speed of the carrier 4 in its working section 2-2.

In the FIG. 6 a variant of the planetary-chain-drive as application for a wheelchair is shown; that will allow to a user to move in 2 times faster comparing with the variant according to FIG. 4, if all the rest factors are saved as in the FIG. 4

In the FIG. 7 a variant of the invention is shown, where in contrast to the basic variant according to FIG. 2 and applying to cases when a device, driven by the claimed converter, has a twofold executive part, like as a railway-locomotive has more than one axis of moving wheels, the release of idling can be gotten by doubling of the basic converter mechanism according to FIG. 2. At that the pushers 6, transmitting the motion from a rod 8 to both driving chains 2, are fixed to the opposite branches of the identical driving chains 2; so in the variant of FIG. 7 the pusher 6-2 is fixed to the upper branch of a driving chain 2-2, and the pusher 6-1 is fixed to the lower branch of a driving chain 2-1. The available length of the piston 11 stroke in the cylinder 12 is not here depends on the diameter of the wheels 7; that allows to lengthen the stroke and so improve the efficiency of the machine. R here is the Rail-road. To reverse the locomotive in this version, each of the (two) freewheels 9 can be doubled with coaxial one, oriented oppositely and divided from the first one by a branch/joint sleeve.

In the FIG. 8 a variant of the mechanism according to FIG. 7 is shown, where both chain-sprocket gearing replaced with rack-gear ones similar to the variant according to FIG. 3. This variant is nevertheless beyond the limits of the technology level, unlike the variant of FIG. 3.

In the FIG. 9 a variant of the mechanism according to FIG. 7 is shown, where a rod 8 of a piston engine is driven by two pistons 11. Number of pistons 11 and of cylinders 12 is in principle not limited. This variant of the invention is applied to the 4-stroke internal combustion engine; the numbers 1÷4 denotes the order of the combustion chambers at the performance of the same phases of the working cycle.

In the FIGS. 10, 11 variants of the invention are shown allowing to release from idling for a device having a single executive part, like a wheelchair, in contrast to the devices in FIG. 7. Here, motion is transmitted from the driving chain 2 to the executive element, to the wheel 7 coaxial with the working sprocket 10 through an auxiliary chain 13. Two driven working sprockets 14, 15 are toothed with the driving chain 2 instead of one working sprocket 10.

Then rotation is transmitted to the sprockets 16, 17 which are coaxial with the sprockets 14, 15 and are driving for the auxiliary chain 13. At that sprockets of one of the two pairs of sprockets—either a pair of 14, 15, or a pair of 16, 17—are toothed an opposite sides of the contour of one of the chains: either of the driving chain 2 or of the auxiliary chain 13 and, respectively, the sprockets of this pair rotate in the opposite directions. If the pair of 14, 15 is on the opposite sides of the driving chain 2 contour, as it is shown in FIG. 10, so the freewheels 9 are set in the same direction. If the pair of 16, 17 is on the opposite sides of the auxiliary chain 13 contour, as it is shown in FIG. 11, so the freewheels 9 are set in the opposite directions. The auxiliary chain 13 can be used simultaneously as a speed variator which is not beyond the technology state.

In the FIG. 12 a variant of the invention is shown for a case when the working sprocket 10 is driven through the driving chain 2 by several carriers 4; the quantity of carriers 4 is in principle not limited; in the FIG. 12 there are two of them. Speed of the driving chain 2 at its working branch, toothing the working sprocket 10, is as the double sum of all carriers 4 speeds.

In the FIG. 13, for comparison with FIG. 12, a functionally similar variant of the summarizer-converter with rack-gear is shown, i.e. the variant is in the limits of the technology level; the rack-gear can be placed on the slider, which is the final one in a series of sliders. Here, however, driving sliders can move only parallel to each other, that makes constructive restrictions.

The FIGS. 14, 15 are modified variants of the invention variant given in the FIG. 12; they show advantages of the invention, comparing with a variant of FIG. 13; FIG. 14 shows the constructive freedom, due to non-requirement for carriers 4 to move parallel to each other; FIG. 15 shows that carriers 4 can move neither rectilinearly nor as translation too; total length of sprockets intercenter distances becomes variable, that is why a tension sprocket 19 can be needed.

In the FIG. 16 a variant of the invention is shown, where the motions of both a pusher 6 and a carrier 4 are summarized. At the full braking of the pusher 6 with section 2-2 of the driving chain 2, the speed of its working section 2-3 is equal to twice speed of the carrier 4; at the full braking of the carrier 4, the satellite sprockets 5 become usual fulcrum sprockets 3, and the speed of the driving chains 2 at its working section 2-3 becomes equal to the speed of the pusher 6; at the work of both these driving elements, i.e. the pusher 6 and the carrier 4, the speed of the working section 2-3 is equal to the sum of the speed of the pusher 6 and double speed of the carrier 4. Transport devices with this type of muscular drive will have advantages over both wheel devices with drive of treadle type and natatorial devices of rowing type.

In the FIG. 17 a variant of the invention is shown as applied to the 4-stroke internal combustion engine with two cylinders. Here the speed of the driving chain 2 at its working branch, in the zone of its toothing with sprockets 14, 15, is 4 times greater than the speed of doubled carrier 4 or of the piston 11, that allows to soften its working regime. The other advantages of this variant of the engine are
equability of the force transduction to the working sprocket 10 from the piston 11 during length of its working stroke,
lack of constructive limits on the stroke length,
the possibility to reduce the number of cylinders 12 by placing two combustion chambers in each cylinder.

In the FIG. 18 a variant of the invention is shown as applied to a steam machine capable to replace the steam turbine in force and power units. It is shown here also, that
satellite sprockets 5 can be of different sizes;
a carrier 4 can be moved by a cylinder 12 while a piston 11 is moveless;
the relation between speeds of the cylinder 12 and a working section of the driving chain 2 can be adjusted constructively due to number of satellite pairs on a carrier 4 which is limitless, that is shown conditionally by breaks of the driving chain 2 and the carrier 4.

In the FIG. 19 the variant of the invention is shown as applied to a piston engine with three carriers 4, two of which, 4-2, 4-3 can be braked, and so only the carrier 4-1 works and the working section of the driving chain 2 moves with the double speed of the engine piston; if only the carrier 4-3 is braked, and the carrier 4-2 is connected with the engine piston through the carrier 4-1, the working section of the driving chain 2 moves with the speed of 4 times more than speed of the engine piston; if all the three carriers moves the working section of the driving chain 2 moves with speed of 6 times more than speed of the engine piston, i.e. this variant realizes a gear-box function. In the FIG. 20 the simplest variant of such gear-box with two latches 18 is shown.

In the FIG. 21 the variant of the invention is shown as applied to the natatorial device with a muscular drive for a rowing screw 19 which has such advantages over an oar drive, as:
(1) ability to pass narrow channels where oars rest on coast,
(2) ability to place an oarsman with his face to a course of the boat,
(3) ability of continuous drive of the screw 19—without idling.

There are two conic gearings 20, 21 here and a chain-drive with sprockets 23, 24 and a chain 25 transmit motion to the screw 19 across a board of the device, and cylindrical toothing 26 allows to turn the rowing screw 19 for maneuvering.

1.-10. (canceled)

11. A mechanism for conversion of reciprocal-linear motion into unilateral rotation, comprising:
a chain-drive and a freewheel;
wherein a driving element of the chain-drive is its driving chain itself;
wherein at least one sprocket is driven by the driving element;
wherein the driving chain gets reciprocal-linear or back and forth motion from a pusher or at least one carrier, or from both of them;
wherein swinging/reciprocal rotation of the sprocket is transmitted to a driving part of an executive unit transforming into unilateral rotation either by the freewheel or by two freewheels and an auxiliary chain.

12. The mechanism according to claim 11, wherein a pusher is immediately fastened to the driving chain.

13. The mechanism according to claim 11, wherein the carrier is connected with the driving chain through a pair of sprockets, axes of which are rigidly fixed on the carrier, wherein the sprockets are satellite sprockets and in that they are mobile relative to a frame, and are toothing the driving chain on an external side of its contour opposite to the side of a working sprocket toothing, and thus each carrier creates a mobile-closing of the driving chain and a loop in its contour, that makes the chain-drive into a planetary chain-drive, separate sections of which move at different speeds.

14. A method to transform reciprocal-linear, back-and-forth motion into unilateral rotation by use of chain-sprocket toothing and a freewheel, wherein the reciprocal linear motion of at least one driving element of at least one chain-drive is transformed into interrupted rotation of at least one working sprocket of the chain-drive, and then using of at least one freewheel is transformed into a unilateral rotation of at least one executive element either directly or through an auxiliary chain.

15. The method according to claim 14, wherein a driving element of the chain-drive is made as a pusher which is fastened immediately to the driving chain.

16. The method according to claim 14, wherein a driving element of the chain-drive is made as a carrier, axes of a pair of mobile, satellite sprockets are fixed on which the sprockets create a mobile-closing of the driving chain contour by toothing the driving chain on the external side of its contour or the opposite side of the working sprocket toothing.

17. The method according to claim 14, wherein a driving chain is moved by at least two driving elements.

18. The method according to claim 14, wherein two driving chains are fastened immediately to a sole pusher.

19. The method according to claim 14, wherein motion is transmitted from the driving chain to an executive element through an auxiliary chain, wherein motion is transmitted to the auxiliary chain through two pairs of coaxial sprockets, wherein each of these two pairs are connected together through a free-wheel, wherein the sprockets are toothing the driving chain on the different sizes of its contour and the free-wheels are directed equally.

20. The method according to claim 14, wherein motion is transmitted from the driving chain to an executive element through an auxiliary chain, wherein motion is transmitted to the auxiliary chain through two pairs of coaxial sprockets, wherein each of these two pairs are connected together through a free-wheel, wherein the sprockets are toothing the auxiliary chain on the different sizes of its contour and the free-wheels are directed oppositely.
